(19) United States
(12) Patent Application Publication
(10) Pub. No.: US 2005/0056064 A1
(43) Pub. Date: Mar. 17, 2005

(54) Quality organic fertilizer

(76) Inventor: James Joyce, Andover, NY (US)

Correspondence Address: Shlesinger, Fitzsimmons & Shlesinger, Suite 1323, 183 East Main Street, Rochester, NY, 14604, US

(21) Appl. No.: 10/658,909

(22) Filed: Sep. 11, 2003

(51) Int. Cl. C05F 3/00

(52) U.S. Cl. 71/12

(57) ABSTRACT

This patent application is for the formulation of an organic agricultural fertilizer. This product meets the standards of the U.S. Department of Agriculture (USDA). The material used is municipal sludge from treated municipal plants. The raw material meets the guidelines of the United States Environmental Protection Agency (USEPA). The sludge is treated with various additives to eliminate pathogens. Globally acceptable additives are added to the base material to produce the fertilizer. The macronutrient materials include phosphates, potash, and nitrates. In addition, liquid ammonia is used to add nitrogen and eliminate pathogens.

### FIELD OF INVENTION

A fertilizer, which includes stabilized treated sludge from wastewater treatment plants, acts as a base for the addition of nitrates, phosphates, and potash to produce a fertilizer equivalent to commercial fertilizers

During production of the fertilizer, additives of lime, ammonia prills, phosphoric pentoxide, potassium oxide and liquid ammonia are added to produce a commercial fertilizer of agricultural strength, e.g. 2-2-2, or 5-5-5. These additions result in a pH of 12.0-13.5. Pathogens are destroyed at these levels of pH. Pathogens such as bacteria, viruses, protozoa and Helminth worms are destroyed. Mineralization, which is the decomposition of the organic molecules to release inorganic ions, must occur before plants can use these elements. Sewage with an average composition of approximately 3.3% nitrogen, 2.3% phosphorous and 0.3% potassium is used as a base for this product fertilizer/conditioner. The chemicals will be added to make up 2-2-2 fertilizer.

### BACKGROUND OF THE INVENTION

A general discussion on the production of a high quality organic based fertilizer follows.

Throughout history, exhausting their fields of nitrogen, phosphorous and potash destroyed civilizations and potash as these nutrients are removed from the soil in large quantities by plants. Nitrogen and water are the most limiting factor in crop output worldwide. The fertilizer described here, produced at modest costs will decrease on-going costs both for the farmer in the United States and Latin America. The most widely used nitrogen fertilizers are produced from chemicals. These fertilizers are very concentrated and expensive. Nitrogen for commercial chemical fertilizers come from ammonia derived from fossil fuels and prices fluctuate depending on the world markets. This fertilizer will depend on sewage sludge for the base, which already contains an average of 3.3% nitrogen.

Municipal Sludge

Municipal Sludge is presently being used for agricultural purposes. Between 40-50% of the sludge being generated is being applied on agricultural land. A typical analysis of the direct application of macronutrients and micronutrients follows.

The process described in this paper produces a balanced fertilizer for the farmer. The ratio of nitrate to phosphate to potash can be adjusted for each crop for maximum growth. In addition the organic matter would help maintain the humus in the soil, and acts as a soil conditioner. Presently millions of tons of sludge are being landfilled thereby concentrating chemical substances that invade groundwater.

Heavy Metals

Only municipal waste streams will be used with this process that are naturally low in quantity of heavy metals. Since each municipality must test for heavy metals in their waste streams we will use their analytical records to screen for our use. That is they must be below the maximum contamination level (MCL) for land application. Wastewater Treatment Plants must determine the source of these heavy metals and work with the source material generator to prevent heavy metals from contaminating the sludge.

TABLE 1
TYPICAL COMPOSITION OF RAW AND ANAEROBICALLY
DIGESTED PRIMARY SLUDGES

| | | | Anaerobically | |
|---|---|---|---|---|
| | | | Digested | |
| | Raw Primary Sludge | | Primary Sludge | |
| Item | Range | Typical | Range | Typical |
| Total dry | 2-7 | 4 | 6-20 | 10 |
| solids (TS), % | | | | |
| Volatile solids | 60-80 | 65 | 30-60 | 40 |
| (% of TS) | | | | |
| Grease of fats | 6-30 | — | 5-20 | — |
| (ether soluble | | | | |
| % of TS) | | | | |
| Protein (% of TS) | 20-30 | 25 | 15-20 | 18 |
| Nitrogen | 1.5-4 | 2.5 | 1.16-6 | 3 |
| (N, % of TS) | | | | |
| Phosphorus | .08-2.8 | 1.6 | 1.5-4 | 2.5 |
| (P2O5, % of TS) | | | | |
| Potash | 0-1 | 0.4 | 0-3 | 1 |
| (K2O, % of TS) | | | | |
| Cellulose (% of TS) | 8-15 | 10 | 8-15 | 10 |
| Iron (not as sulfide) | 2-4 | 2.5 | 3-8 | 4 |
| Silica | 15-20 | — | 10-20 | — |
| (SiO2, % of TS) | | | | |
| pH | 5-8 | 6 | 6.7-7.5 | 7 |
| Alkalinity | 500-1,500 | 600 | 2,000-3,500 | 3,000 |
| (mg/l as Ca Co3) | | | | |
| Organic acids | 200-2,200 | 500 | 100-600 | 200 |
| (mg/l as HAc) | | | | |
| Thermal content | 6,800-10,000 | 7,600a | 2,700-6,800 | 4,000b |
| (BTU/lb.) | | | | |

Appendix A

FIG. 2

TYPICAL ANALYSIS OF SLUDGE MICRONUTRIENTS

| N | 2.800% dry wgt basis | 1,600 wet (mg/l) |
|---|---|---|
| P | 1.300% | 741.00 |
| K | 1.100% | 627.00 |
| Ti | 0.180% | 103.00 |
| Cr | 0.021% | 12.00 |
| Mn | 0.035% | 20.00 |
| Fe | 1.700% | 970.00 |
| Co | 0.001% | 0.60 |
| Ni | 0.024% | 14.00 |
| Cu | 0.130% | 74.00 |
| Zn | 0.400% | 228.00 |
| Br | 0.002% | 1.10 |
| Rb | 0.004% | 2.30 |
| Sr | 0.037% | 22.00 |
| Y | 0.010% | 5.70 |
| Zr | 0.041% | 23.00 |
| Mo | 0.006% | 3.40 |
| Ag | 0.007% | 4.00 |
| Cd | 0.003% | 1.70 |
| Sn | 0.020% | 11.00 |
| Ba | 0.170% | 97.00 |
| Pb | 0.170% | 97.00 |

Specialized Fertilizer

This specialized fertilizer used on crops in field trials produces higher yields than the conventional commercial fertilizer. The higher yields result when the sludge fertilizer is used. Further, the sludge fertilizer provides moisture around the root system of the plants due to the action of deliquesce, a property of absorbing water from moisture in the air. This action tends to keep plant nutrients and water near the roots and reduces leaching and minimizes erosion. Theoretically a 30±1% increased crop yields results. This increase makes our process a better substance over sludge deposition in a landfill.

The organic material in sludge originates in the dietary fiber of humus. Humus is best described as a brown to black matrix of humic substances produced by the decay of organic matter. The humic and fulvic acid components are biochemically active.

In summary to the above benefits, there is an increase in soil aeration, improved soil workability, reduced soil erosion and an improved draught tolerance besides adding nitrogen to the soil.

Pathogens

Pathogens are organisms or substances capable of causing disease. In our discussion pathogens are living organisms, except where specified. Pathogens infect humans through several different pathways including ingestion, inhalation, and dermal contact.

Pathogens that propagate in the enteric systems of humans and are discharged pose the greatest risk to public health with regard to the use and disposal of sewage sludge. Pathogens are also found in the urinary and enteric systems of other animals and may propagate in non-enteric setting.

The four major types of human pathogenic organisms that may be in municipal sludge are bacteria, viruses, protozoa, and helminths and all may be present in the domestic sewage from a particular municipality. Nevertheless, the resulting biological sewage sludge may still contain sufficient levels of pathogens to pose a public health and environmental concern. EPA Regulation Part 305 requires sewage sludge to be treated by a Class A pathogen treatment process or a Class B process with site restrictions.

Outside various set conditions, survivability of pathogen decreases. Some of the factors, which influence the survival of the pathogens, include pH, heat, competition from other microorganisms, sunlight, contact with host organisms, proper nutrients and moisture level.

Our system of treating parasites disallows the reinjection of the fertilizer through protozoan cysts or helminth ova.

Pathogens

There are four major types of human pathogens in sludge: Bacteria, Viruses, Protozoa, and Helminths. We have investigated different types of domestic sewage.

Bacteria

Fecal coliform and E. coli bacteria were used as indicators for the absence or presence of bacterial pathogens in sewage sludge. Fecal coliform bacteria are abundant in human feces and therefore are always present in untreated sludge. When processing sludge, studies of aerobic or anaerobic digestion of sludge have shown the reduction of the pathogens will be significant and sufficient. With our additives we have not found regrowth of pathogens. In outdoor tests of time we have not found pathogens and we conclude that environmental ammonia is Cryptosporidium sp oocytes. A high pH, along with liquid ammonia inactivates oocytes. Restrictions of sludge fertilizer applications are written into a regulation that concerns the types of crops grown, etc.

Class A Biosolids—Pathogen Requirements

Requirements to reduce pathogens below detectable limits are:

| | |
|---|---|
| 1. Salmonella sp- | <3 MPN/4 g biosolids |
| 2. Enteric viruses- | <1 PFU/4 g of biosolids |
| 3. Viable helminth ova- | <1 helminth ova/4 g biosolids |

Monitoring of fecal coliform<1000 IVIPN/g total solid
Sewage Sludge—Eliminating Pathogens
1. Elevate the pH to greater than 12 and maintaining this pH for more than 72 hours
2. Maintaining the temperature above 52° C. (126° F.) throughout the sewage sludge for at least 12 hours during the period the pH<12
3. Air-drying to over 50% solids after the 72-hour period of elevated pH.
4. Hydrated lime, quicklime, and calcium oxide may be used to reduce bacterial and viral densities effectively.

It is recommended that biosolids applications take place while the pH remains elevated. If this is not possible, and the odor problems develop, alternate management practices in the field include injection or incorporation of top dressing the biosolids with additional lime. Lime stabilization can reduce bacteria and viral pathogens by 99% or more.

Benchtop Formulations Used for Bacteria Status

The status was tested using Colilert by IDEXX Laboratories, Inc. Colilert is used for the simultaneous detection and confirmation of total Coliform and E-Coli by defined Substrate Technology.

A trial includes the use of hydrated lime, liquid ammonia and ammonia prills as a formula to destroy pathogens in sludge. The ingredients were mixed and let set for 2 hours and then tested.

The test method used was by obtaining a “seed” of about 3 grams, stirring it into sterilized, 100 ml jars, filled with sterilized water, and unit doses of the substrate were added and stirred. Each test sample was incubated at 35±0.5° C. for 24 hours. Fecal Coliform presence is indicated by a yellow color in the 100 ml jar. At the same time an ultraviolet light is used to detect E-Coli: If E-Coli is present, florescence occurs in a dark room which indicates a presence.

Production of Fertilizer from Sludge in the Laboratory

TRIAL 1

| | |
|---|---|
| 9 oz (range 8.0-10.0 oz) Sludge | Transfer small section |
| | into |
| 1 oz (range 0.90-1.10 oz) of Hydrated Lime | Bacteria Bottle |
| 1 oz (range 0.90-1.10 oz) Ammonia Prills | Add Colilert |

TRIAL 2

| | |
|---|---|
| 9 oz (range 8.0-10.0 oz) Sludge | Transfer small section |
| | into |
| 0.5 oz (range 4.50-5.50 oz) Hydrated Lime | Bacteria Bottle |
| 0.5 oz (range 4.50-5.50 oz) Ammonia Prills | Add Colilert |

TRIAL 3

| | |
|---|---|
| 9 oz (range 8.0-10.0 oz) Sludge | Transfer small section |
| | into |
| 1 oz (range 0.90-1.0 oz) Hydrated Lime | Bacteria Bottle |
| 0.5 oz (range 4.50-5.50 oz) Phoshate & Potash | Add Colilert |
| 0.5 oz (range 4.50-5.50 oz) Ammonia Prills | Incubate at 35° C. for |
| | 24 Hours |

1.5 oz (range 1.20-1.80 oz) Treated Sand with Liquid Ammonia
TESTING FOR COLI FORM AND E. COLI BACTERIA TRIALS

Trails Using Additives
Introduction

The results of the addition of 4% liquid ammonia and ammonia prills affected the 30% solid/70% moisture ration with the result of a sloppy product, but with good destruction of pathogens.

Trial A (−/−)

Trial A consisted of combining sludge (258 g) (range 236.0-260.0 g), liquid ammonia (25 g) (range 23.0-27.0 g), hydrated lime (50 g) (range 47.5-52.5 g) and ammonia prills in a sand mix (45 g) (range 41.50-49.50 oz). When the material was mixed the mix temperature went to 92° F., one hour later the temperature was 98.8° F., and two hours later 89° F. This additive did destroy the pathogens in the sludge samples.

Trial B (−/−)

Sludge (250 g) (range 238.0-262.0 g), Lime (50 g) (range 48.0-52.0 g), liquid ammonia (20 g) (range 19.0-21.0 g) and sand were mixed and stored for 2 hours and tested for P/A of fecal coliform and E-Coli. No fecal coliform (−) nor E-Coli (−) was found.

Trial C (−/−)

Sludge (50 g) (range 47.5-52.5 g), ammoniated sand (8 g) (range 7.60-8.40 g), and liquid ammonia (20 ml) (range 19.0-21.0 g) were mixed and stored for 2 hours (range 1.50-2.50 hours) at room temperature. Using SOPs for the Colilert tests no bacteria was found.

Section: Modified with Formaldehyde

A

500 Grams (range 475.0-525.0 g) of Sludge
75 Grams (range 71.0-79.0 g) of Lime
2.5 Grams (range 2.30-2.70 g) of Treated Sand
10 Milliliters (range 8.0-12.0 ml) of Alcohol
   Let stand for 10 hours at room temperature, then put the seed bottle in the incubator for 24 Hours, add Colilert to the bottle.
   B
250 Grams (range 238.0-262.0 g) of Sludge
50 Grams (range 47.0-53.0 g) of Lime
20 Grams (range 18.0-22.0 g) of Treated Sand
   Two hours later put the seed bottle in the incubator and add more Colilert.
   C
500 Grams (range 475.0-525.0 g) of Sludge Treated Lime
8 Grams (range 76.0-8.40 g) of Treated Sand
10 Milligrams (range 8.0-10.0 ml) of Ammonia Prills
20 Milliliters (range 19.0-21.0 ml) of Ammonia
   Two hours later put the seed bottle back in the incubator and add more Colilert.
   Production
   I. Producing 5-5-5 Fertilizer

The production of multinutrient fertilizer described on preceding pages is a fertilizer containing several additives; sludge, hydrated lime, liquid ammonia, ammonia prills, phosphate (P2O5), potash (K2O), and sand impregnated with liquid ammonia.

Table 1 illustrates the components of 5-5-5 fertilizer to be produced. Specific quantities of nitrogen, phosphate and potash are included to make one hundred pounds (100 lbs.) of each. As table I indicates, fertilizer units refers to 20 lbs. or 5 units in 100 lbs. thus, the 5-5-5 fertilizer.

Table I also illustrates how the lime component is used as pH adjustment to reach a pH of 12 (range 12.0-13.5 pH) to destroy pathogens.

II. Steps in Fertilizer Production

Steps are outlined for the production of fertilizer on pages that follow describing each step and block diagram displaying each sequence.

Table A-Chemical Guidelines For Sludge

Table A-Chemical Guidelines for Sludge gives a list of regulated heavy metals and their maximum regulatory level. We will not use sludge from wastewater treatment plants that are over these levels.

TABLE 1
ORGANIC FERTILIZER COMPOSITION OF 5-5-5

| | Total Weight of | Portion of Total Weight Providing Usable | | |
|---|---|---|---|---|
| | Ingredients per | Nutrients | | |
| | Ton of Product | Nitrogen | Phosphorus(P₂O₅) | Potassium(K₂O) |
| Organic Sludge* | 1,800 lbs. | 61 lbs. | 69 lbs. | 11 lbs. |
| Chemical Additives: | | | | |
| Urea/Ammonia | 83 lbs./equivalent | 39 lbs. | | |
| P₂0₅ | 31 lbs. | | 31 lbs. | |
| K₂0 | 89 lbs. | | | 89 lbs. |
| Totals: | 2,003 lbs. | 100 lbs. | 100 lbs. | 100 lbs. |
| Weight of Usable | 300 lbs. | 100 lbs. | 100 lbs. | 100 lbs. |
| Nutrients for | | | | |
| 5-5-5 Fertilizer | | | | |
| Units Available | | 5 | 5 | 5 |
| (“Unit” refers to | | | | |
| 20 lbs., or 1% of | | | | |
| a ton in nutrients | | | | |

100 lb. Limestone CaO (1.5% Mg) for a pH adjustment

| | | |
|---|---|---|
| Equations: | 1) 4P + 50₂ = 2P₂O₅ | % P in P₂O₅ 62P/ = 44% |
| | 124 + 160 = 284 | 142 P₂O₅ |
| | 2) 4K + O₂ = 2K₂O | % K in K₂O 39.1K/ = 42% |
| | 156 + 32 = 188 | 94K₂O |

Organic sludge is dried to a point where it contains 30% dried humus nutrients and only 70% water. The water content is needed to facilitate handling and assure activation of the humus and nutrients in soil.
** Only approximately 47 or 48 percent of the urea activates as usable nitrogen, necessitating a higher weight of urea in the mix than is the case for P205 and K20.
II. Steps In Fertilizer Production
1. Wastewater Treatment Plants in the United States produce both digested and undigested sludge which we will use as a base for the fertilizer.
2. All sludge will be tested for heavy metal organic compounds, and pathogens. Sludge with chemicals below the Maximum Contamination Level (MCL) will be used. (see Table a “Chemical Guidelines for Sludge”, page 32.)
3. Conveyors, trucks, or ocean barges will transport the municipal sludge to a processing plant.
4. The sludge will be stockpiled in a protected area.
5. Next, the sludge may be further dried and the dried sludge will be loaded onto a conveyor belt to be treated.
6. A conveyor belt then empties the treated sludge into a large mixing chamber where micro and macro nutrients are added to make a 2-2-2 or other grade fertilizer (hydrated lime, potash, phosphate, ammonia prills, ammonia liquid and urea.
8. After the material is thoroughly mixed a conveyor belt will carry the fertilizer onto a hopper.
9. Mechanical transports, such as truck or barges, then will carry the finished product either to a bagging station or bulk storage facility.

10. The bagged bulk fertilizer is then stored for shipping in a protected building.

TABLE A
CHEMICAL GUIDELINES FOR SLUDGE

| | Title 360 | Maximum Level |
|---|---|---|
| | Maximum Regulatory | Agricultural Soil |
| Parameter | Level (mg/kg) | (lbs./acre) |
| (v) Cadmium, ppm | 25 | 3-4 |
| (vi) Zinc, ppm | 2500 | 150-223 |
| (vii) Copper, ppm | 1000 | 75-112 |
| (viii) Nickel, ppm | 200 | 30-45 |
| (ix) Lead, ppm | 1000 | 300-446 |
| (x) Chromium, ppm | 1000 | 300-446 |
| (xi) Mercury, ppm | 10 | |
| (xxi) Total Cyanide, ppm | | |
| PCB | <10 | |
| TOX | <10 | |

The above outline illustrates those heavy metals in sludge regulated under Title 360 which refers to the solids or semisolids resulted from the treatment of wastewater from wastewater treatment plants. Also, the maximum contamination level (MCL) for heavy metals for land application are listed.

The Novel Composition of this Invention

The novel composition of this invention is the use of uncontaminated municipal sludge and the combination of additives that are not commonly used in commercial fertilizer.

Commercial fertilizers are made up of a source of phosphorus, potassium and nitrogen in the form of nitrate in urea, etc. The main ingredient of the new fertilizer is municipal sludge, phosphate and potash. Other additives such as prills and liquid ammonia are used for odor control, nitrogen source, and pathogen control. Formaldehyde and phenol are used primarily for pathogen control.

1. A method of producing a municipal based sludge fertilizer by mixing the following: municipal sludge (83%), comprised of solids (30%), liquids (70%). In addition lime (12.5%), liquid ammonia prills (1.3%), potash (1.2-1.4%), phosphate (1.3%), calcium (1.0%), liquid ammonia (2.5 gallons of approximately 50% concentration).

2. The substance composition as recited in claim 1 is used as a base to control odors. In one embodiment, agricultural lime, ammonia prills and liquid ammonia are used to modify odors to make the resultant odors less intense and more tolerable. In another embodiment commercial odor neutralizers may be used.
